(19) United States
(12) Patent Application Publication
(10) Pub. No.: US 2020/0149598 A1
(43) Pub. Date: May 14, 2020

(54) METHOD FOR DETERMINING A SERVICE LIFE OF A FRICTION CLUTCH OF A VEHICLE

(71) Applicant: SCHAEFFLER TECHNOLOGIES AG & CO. KG, HERZOGENAURACH (DE)

(72) Inventors: Henrik BEIER, Karlsruhe (DE); Baschar IBRAHIM, Durmersheim (DE)

(73) Assignee: SCHAEFFLER TECHNOLOGIES AG & CO. KG, HERZOGENAURACH (DE)

(21) Appl. No.: 16/603,457

(22) PCT Filed: Mar. 7, 2018
(86) PCT No.: PCT/DE2018/100206

§ 371 Date: Oct. 7, 2019

(30) Foreign Application Priority Data
Apr. 7, 2017 (DE) 10 2017 107 491.0

(51) Int. Cl. F16D 48/02

(52) U.S. Cl. CPC F16D 48/02; F16D 2500/30406; F16D 2500/7082; F16D 2500/50236; F16D 2500/5102; F16D 2500/5023; F16D 2500/30402

(57) ABSTRACT

A method for determining a service life of a friction clutch of a vehicle with a clutch actuation system includes setting a maximum torque at the friction clutch of the clutch actuation system. The method also includes incrementing a service life counter when an unintended slip at the friction clutch occurs, determining that wear has occurred on the friction clutch in response to reaching a specific counter value of the service life counter, and multiplying a weighted sensitivity factor by a first absolute vale which increments the counter in response to an unintended slip occurring.

### CROSS-REFERENCE TO RELATED APPLICATIONS

This application is the U.S. National Phase of PCT/DE2018/100206 filed Mar. 7, 2018, which claims priority to DE 102017107491.0 filed Apr. 7, 2017, the entire disclosures of which are incorporated by reference herein.

### TECHNICAL FIELD

The disclosure relates to a method for determining a service life of a friction clutch of a vehicle, in which method a maximum torque is set at the friction clutch, and, when an unintended slip occurs at the friction clutch, a service life counter is incremented, wherein, when a specific counter value of the service life counter is reached, it is concluded that wear has occurred on the friction clutch.

### BACKGROUND

DE 101 31 434 A1 discloses a wear detection device and method in which a wear index relating to the service life of the clutch and at least one further service-dependent clutch value are formed. Depending on at least these two values, a wear detection signal is output. Here, wear detection is performed with the aid of a counter, the count of which can be both incremented and decremented. This counter is calculated in accordance with the wear index after each concluded adaptation process. When the counter has reached its maximum value and, at the same time, at least one further operational value has reached or exceeded a predetermined limit, clutch wear is inferred.

DE 10 2016 218 613.2, which is an as yet unpublished German application by the applicant, discloses a method for monitoring the state of functioning of an automated clutch actuating system, in which a period of time in which the hydrostatic clutch actuator is moved from a first position to a second position is determined and compared with a time threshold, wherein, if the time threshold is exceeded, functional impairment of the clutch actuating system is inferred. When the time threshold is exceeded, a counter is incremented, wherein reaching of the maximum time limit is recognized if the counter has reached a predetermined count.

The solutions described have the disadvantage that they can only be used for dry clutches.

### SUMMARY

It is the underlying object of the disclosure to specify a method for determining a service life of a friction clutch of a vehicle which can be applied to all clutch systems.

According to the disclosure, the object is achieved by virtue of the fact that, when unintended slip occurs, a first absolute value which increments the counter is multiplied by a weighted sensitivity factor. This has the advantage that the method can be applied not only to dry clutches but also to wet clutches and to hybrid separating clutches in hybrid vehicles since the specific wear properties of the friction clutches are taken into account by the weighting of the sensitivity factor.

In a development, in order to set the weighted sensitivity factor, a predetermined sensitivity factor is weighted in accordance with thermal effects and/or with adaptive parameters measured during a clutch control operation and/or with current quantities to be measured determined in the clutch actuating system. The wear in the current clutch state is thereby verified, this being taken into account in the setting of the counter.

It may be advantageous if the predetermined sensitivity factor is reduced when thermal effects occur in a dry friction clutch, whereas the predetermined sensitivity factor is increased when thermal effects occur in a wet friction clutch. In this way, the differing behavior of dry friction clutches, in which a wear effect due to the occurrence of abrasion of the clutch lining can be healed, as compared with wet friction clutches, in which the wear remains unchanged, is incorporated into the evaluation.

In one embodiment, a number of test events to be counted is reduced when thermal effects occur at the wet friction clutch. Here, it is assumed that, in the case of wet friction clutches, in which the wear effects cannot be healed, the service life limit is reached after fewer events, and therefore fewer measurement points are required to obtain a reliable verdict on the state of wear of the friction clutch.

In one variant, the predetermined sensitivity factor is weighted by parameters adapted during a clutch control operation, wherein these productive parameters are evaluated when the maximum torque is acting on the friction clutch, and a long-term friction coefficient and/or a long-term bite point of the friction clutch are considered as adaptive parameters. Such continuously adapted adaptive parameters indicate, through the trend in the change thereof, the presence of damage to the friction clutch or the reaching of the end of the service life thereof, for which reason an unintended slip event is weighted with a higher sensitivity. This approach is based on the fact that, with increasing wear, the long-term friction coefficient decreases and the long-term bite point rises. Using the adaptive parameters, it is thus possible from the monitoring of the current clutch state to detect in real time whether the service life of the friction clutch has expired.

In a particularly simple embodiment, the predetermined sensitivity factor is increased when a bite point threshold is exceeded by the long-term bite point, whereas the predetermined sensitivity factor is reduced when the bite point threshold is undershot by the long-term bite point.

Direct checking of the plausibility of the service life from measured sensor signals is possible if a maximum permissible travel or a maximum permissible pressure of a clutch actuating system for the setting of the maximum torque is calculated from a clutch model, wherein the measured quantities to be measured, namely pressure or travel, are compared with the model quantities calculated from the clutch model, and, if there is a difference between the measured quantities to be measured and the calculated model quantities, the predetermined sensitivity factor is adapted in order to set the weighted sensitivity factor. Here, account is taken of the fact that model deviations can reduce the permissible maximum position of the friction clutch, with the result that the physical maximum torque is not available at the friction clutch. In this situation, an unintended slip event is due to a model error.

It is advantageous if, when a difference is ascertained between the calculated model quantities and the measured quantities to be measured after a first slip event, the predetermined sensitivity factor selected is smaller, wherein the sensitivity factor is increased in each subsequent measurement when the unintended slip occurs. It is assumed here that, when checking the quantities to be measured, it has been ascertained that the maximum pressure or the maximum physically permissible travel when the maximum torque is applied at the friction clutch has not been achieved with a calibratable tolerance. Since this model deviation can already be rectified by adaptation before the next slip event occurs, the sensitivity factor is reevaluated when an unwanted slip event occurs again.

In one embodiment, the sensitivity factor remains at a reduced value until the currently measured adapted quantities to be measured correspond to the calculated model quantities. Here, it is assumed that, after a model deviation, the deviations are gradually re-adapted to the actual clutch actuating system 1. Once this has been achieved, it is assumed that the model and the actual system coincide again. By using the plausibility check, it is possible to prevent incorrect detection of the end of the service life due to model errors.

In a development, the counter is reduced by a second absolute value if the unintended slip does not occur. The wear properties of dry clutches are allowed for by the separate evaluation of the correct operating states of the friction clutch. In the case of dry clutches, states of wear arise when there is overheating of the dry clutch, for example, and can lead in the short term to fault indications. Since the dry clutch returns to its normal state when the overheating recedes, this can be determined by the test for correct functioning of the clutch, and the counter can be set in accordance with this measurement function.

When the maximum engine torque is applied without the occurrence of unintended slip, the counter is advantageously reduced by a predetermined second absolute value if the slip does not occur for a predetermined period of time. The use of the same method enhances robustness in respect of incorrect identification of the end of the service life of wet clutches.

### BRIEF DESCRIPTION OF THE DRAWINGS

The disclosure allows numerous embodiments. One of these will be explained in greater detail by the figures of the drawing.

In the drawing:

FIG. 1 shows a schematic structure of a hydrostatic clutch actuating system,

FIG. 2 shows an illustrative embodiment of the method according to the disclosure,

FIG. 3 shows a characteristic for the expected aging behavior of adaptive parameters,

FIG. 4 shows a characteristic for actuation thresholds of a hydrostatic clutch actuating system.

### DETAILED DESCRIPTION

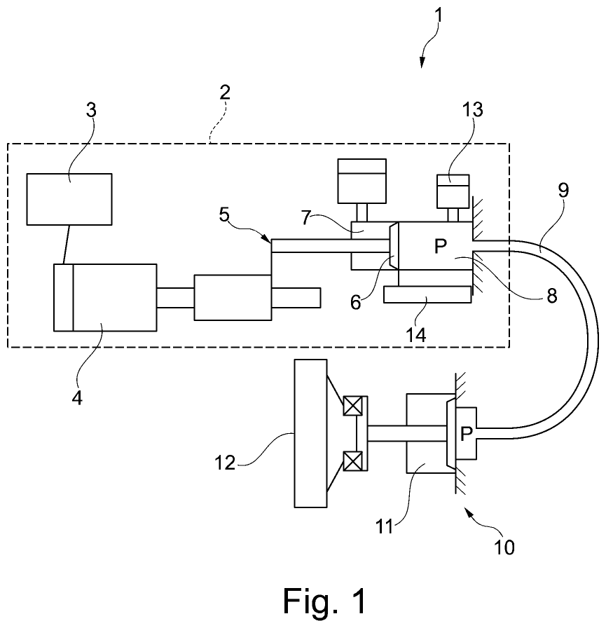

In FIG. 1, the construction of an automated clutch actuating system 1 is illustrated schematically using the example of a schematically illustrated hydraulic, hydrostatic clutch actuator of the kind used in vehicles. On the master side 2, the hydraulic clutch actuating system 1 comprises a control unit 3, which controls an electric motor 4, which, in turn, drives a mechanism 5 for converting the rotary motion of the electric motor 4 into a translational motion of a piston 6 mounted in an axially movable manner within a master cylinder. If a rotary motion of the electric motor 4 causes a change in the position of the piston 6 in the master cylinder 7 to the right along the actuator path, the volume of the master cylinder 7 is changed, as a result of which a pressure p is built up in the master cylinder 7 and transmitted by a pressure medium 8, via a hydraulic line 9, to the slave side 10 of the hydraulic clutch actuating system 1.

In respect of its length and shape, the hydraulic line 9 is matched to the installation space situation in the vehicle.

On the slave side 10, the pressure p of the pressure medium 8 causes a change in the travel in a slave cylinder 11, and this is transmitted to a friction clutch 12 in order to actuate said clutch. The pressure p in the master cylinder 7 on the master side 2 of the hydraulic clutch actuating system 1 can be determined by a sensor 13. The sensor 13 is a pressure sensor. The distance traveled by the clutch actuator is determined by a second sensor 14, which is designed as a displacement sensor.

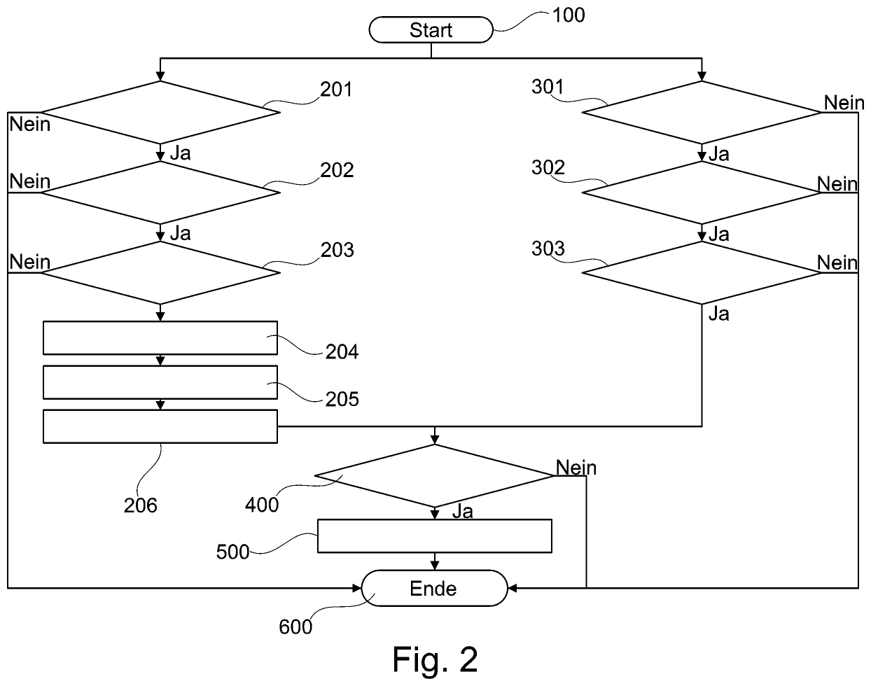

FIG. 2 illustrates an illustrative embodiment of the method according to the disclosure which is carried out by the hydraulic clutch actuating system illustrated in FIG. 1. After the start in block 100, where the friction clutch 12 is activated to transmit a maximum torque, the output divides into a check on the clutch actuating system 1 for incorrect functioning in block 201, while, alternatively, in block 301, the clutch actuating system 1 is checked for correct functioning.

In block 201, the system enquires whether the maximum torque has been demanded and set at the clutch. If this is the case, the system enquires in block 202 whether an unintended slip is above a predetermined slip threshold. Since the slip is represented by a rotational speed at the friction clutch 12, a rotational speed threshold is used as the slip threshold. If the unintended slip is above this rotational speed threshold, the duration of the slip present is checked in block 203. If the measured duration exceeds a time threshold, a plausibility check is performed in block 204, in which a first absolute value to be used to increment a counter is multiplied by a predetermined sensitivity factor. In the plausibility check, adaptive parameters such as a long-term friction coefficient and a long-term bite point, for example, are continuously monitored during the operation of the clutch actuating system 1. It is known that, with increasing wear, the long-term friction coefficient decreases and the long-term bite point rises, this being brought about by abrasion of material from the clutch lining in a dry clutch.

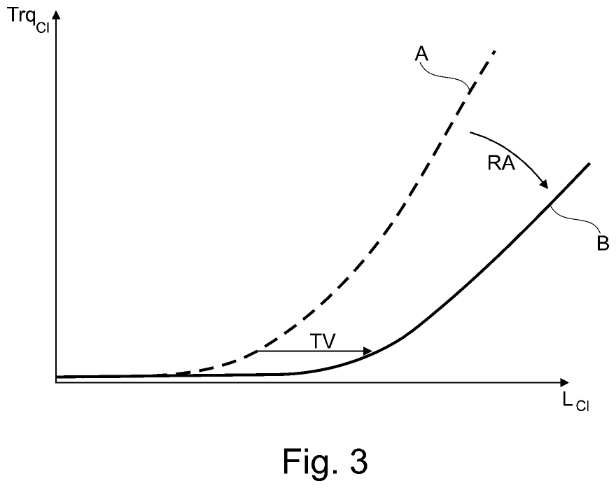

FIG. 3 illustrates a characteristic for an expected aging behavior of the long-term bite point and of the long-term friction coefficient, showing the torque Trq_{CL} of the friction clutch 12 against the actuator positions L_{CL} of the clutch actuator. Here, characteristic A shows the characteristic curve of a new friction clutch 12, while characteristic B illustrates the characteristic curve for a worn friction clutch, wherein the bite point shift TV and the friction coefficient decline RA are illustrated. If, for example, a long-term bite point exceeds a bite point threshold, this confirms that the friction clutch 12 has a corresponding wear and thus a possible end of service life is being reached. In the event of unintended slip, the predetermined sensitivity factor is increased, this corresponding in the case of a high long-term bite point to a high sensitivity. In the case of a lower long-term bite point falling below the bite point threshold, the sensitivity factor selected is smaller than in the case of the high long-term bite point.

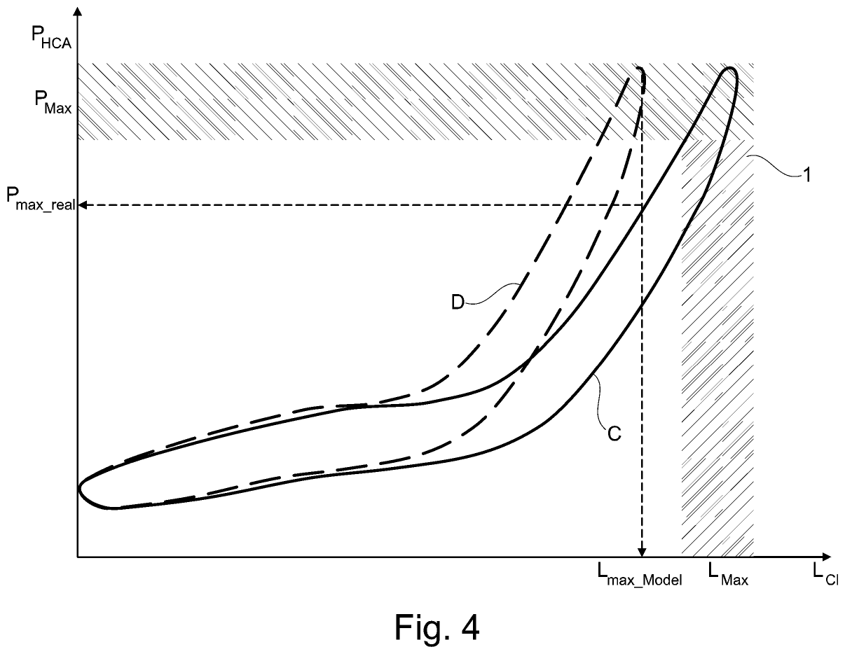

A further plausibility check on the state of wear of the friction clutch 12 can be performed by currently measured quantities to be measured, which are compared with a clutch model. As illustrated in FIG. 4, the actual clutch actuating system 1 is illustrated in regions pₘₐₓ and Lₘₐₓ, which each represent the maximum pressure in the hydraulic clutch actuating system and the maximum actuator travel traveled by the actuator. When setting the maximum torque at the friction clutch 12, the clutch characteristic, which is subject to hysteresis and which corresponds to normal operation (curve C) must end in the maximum regions pₘₐₓ and Lₘₐₓ. However, if model deviations lead to a reduced maximum pressure pₘₐₓ-real leading to a reduced maximum torque of the friction clutch 12, this is described by the model characteristic D. That is to say the maximum pressure pₘₐₓ, as is supposed to be achieved when the maximum torque is applied, is not achieved in the clutch actuation when there are slip situations. This reduced pressure pₘₐₓ₋ᵣₑₐₗ contributes to the actuator travel L_{max-Modell} being shorter than the expected maximum actuator travel Lₘₐₓ.

If such a difference between the travel and pressure values calculated from the clutch model and the travel and pressure values measured in the actual system is ascertained, it is assumed that unintended slip in this situation is based on a model error. If, in the checking of the quantities to be measured, it is ascertained that the maximum pressure or the physically permissible travel has not been achieved with the calibratable tolerance, the predetermined sensitivity factor for service life detection of the friction clutch is reduced. This continues until the adaptation of the quantities to be measured reduces the model quantities sufficiently. During this process, the maximum distance L_{max-Modell} traveled by the actuator is calculated from the actually achieved pressure pₘₐₓ₋ᵣₑₐₗ using the clutch characteristic. Thus, wear-independent assessment as to whether the friction clutch 12 is at the end of its service life is possible.

After the plausibility check, the thermal influences which lead to thermal damage to the lining of the friction clutch 12, e.g. thermal shock or fading, are considered in block 205. In the case of dry friction clutches 12, this thermal damage is healed by abrasion of the lining layer affected. Since an accumulated occurrence of thermal effects, such as fading and thermal shock, delays the detection of a defective clutch when the dry friction clutch 12 is worn, the sensitivity factor in the case of unintended slip with maximum torque applied is reduced. In the case of wet friction clutches, wherein no healing of the affected lining layer is possible, the sensitivity of the wet clutches is increased when fading or thermal shock is detected since damage to the clutch can be expected. That is to say that the predetermined sensitivity factor by which the absolute value is multiplied for incrementation of the counter is increased. In the simplest case, this weighted sensitivity factor can be greater or less than 1. In this case, it is advisable for a number of events to be recorded by the service life counter to be reduced in the case of wet clutches as compared with dry clutches since a defective wet friction clutch 12 can be detected with fewer measurement steps.

Finally, in block 206, the weighted sensitivity factor is calculated from the influences determined in blocks 204 and 205. After the calculation, a transition is made to block 400, where a check is made to determine whether the slip situation and the torque situation have ended. If this is the case, the service life counter is incremented in block 500 in accordance with the first absolute value multiplied by the weighted sensitivity factor. If the slip situation has not yet ended in block 400, the routine continues to the end in block 600.

If the enquiries in blocks 201, 202 and 203 receive a negative answer, the routine is interrupted in block 600.

Beginning with the start 100, where a maximum torque is transmitted by the friction clutch 12, an enquiry is made in block 301 in a test for correct functioning of the friction clutch 12 as to whether the maximum torque is present. If this is the case, the system enquires in block 302 whether the slip is below a slip threshold. If this is the case, the duration of the slip state or adhesion state is determined and the system enquires whether it lasts longer than a predetermined time threshold (block 303). This enquiry as to the duration of the slip is significant since the clutch actuating system 1 settles only over a certain period of time. The observation time begins when a slip below the threshold occurs.

If the slip is less during the entire duration, there is a transition to block 400, where it is ascertained whether the slip situation has ended. In block 500, the service life counter is reduced by a predetermined second absolute value. If it is ascertained in blocks 301, 302 and 303 that the events have not occurred, the evaluation process is ended in block 600.

### LIST OF REFERENCE SIGNS

1 clutch actuating system
2 master side
3 control unit
4 electric motor
5 mechanism
6 piston
7 master cylinder
8 pressure medium
9 hydraulic line
10 slave side
11 slave cylinder
12 friction clutch
13 pressure sensor
14 displacement sensor
p pressure
TV bite point shift
RA friction coefficient decline
A characteristic
B characteristic
C clutch characteristic (normal operation)
D model characteristic
100, 201-206, 301, 302, 303, 400, 500, 600 step

1. A method for determining a service life of a friction clutch of a vehicle, comprising:
setting a maximum torque at the friction clutch;
in response to an unintended slip at the friction clutch, incrementing a service life counter;
determining that wear has occurred on the friction clutch in response to reaching a specific counter value of the service life counter; and
multiplying a weighted sensitivity factor by a first absolute value which increments the service life counter in response to an unintended slip occurring.

2. The method of claim 1, wherein, in order to set the weighted sensitivity factor, a predetermined sensitivity factor is weighted in accordance with thermal effects or with adaptive parameters measured during a clutch control operation or with current quantities to be measured determined a clutch actuating system.

3. The method of claim 2, wherein the predetermined sensitivity factor is reduced when thermal effects occur in a dry friction clutch, whereas the predetermined sensitivity factor is increased when thermal effects occur in a wet friction clutch.

4. The method of claim 3, wherein the method further includes reducing a number of test events to be counted reduced when thermal effects occur at the wet friction clutch.

5. The method of claim 2, wherein the predetermined sensitivity factor is weighted by parameters adapted during a clutch control operation, and these adaptive parameters are evaluated when a maximum torque is acting on the friction clutch, wherein a long-term friction coefficient and/or a long-term bite point of the friction clutch are considered as adaptive parameters.

6. The method of claim 5, wherein the predetermined sensitivity factor is increased when a bite point threshold is exceeded by the long-term bite point, whereas the predetermined sensitivity factor is reduced when the bite point threshold is undershot by the long-term bite point.

7. The method of claim 5, wherein a maximum permissible travel or a maximum permissible pressure of a clutch actuating system for a setting of the maximum torque is calculated from a clutch model, wherein measured quantities to be measured, namely pressure or travel, are compared with model quantities for pressure or travel calculated from a clutch model, and when there is a difference between the measured quantities to be measured and calculated model quantities, the predetermined sensitivity factor is adapted in order to set the weighted sensitivity factor.

8. The method as claimed in claim 7, wherein, when a difference is ascertained between the calculated model quantities and the measured quantities to be measured after a first slip event, the predetermined sensitivity factor selected is smaller, wherein a weighted sensitivity factor is increased in each subsequent measurement when the unintended slip occurs.

9. The method as claimed in claim 8, wherein the weighted sensitivity factor remains at a reduced value until the currently measured adapted quantities to be measured correspond to the calculated model quantities.

10. The method of claim 1, wherein the counter is reduced by a second absolute value when the unintended slip does not occur.

11. A clutch actuating system, comprising:
a controller configured to:
determine whether a maximum torque has been demanded and set at a clutch;
in response to the maximum torque being set at the clutch, determine whether an unintended slip is above a predetermined slip threshold;
determine a duration of the unintended slip; and
multiply a first absolute value to be used to increment a counter by a sensitivity factor when the duration of the slip exceeds a time threshold.

12. The clutch actuation system of claim 11, wherein the clutch actuating system further includes a sensor configured to determine a pressure of a master cylinder of the clutch actuating system.

13. The clutch actuation system of claim 11, wherein the clutch actuating system further includes a sensor configured to determine a distance traveled by a clutch actuator.

14. The clutch actuation system of claim 11, wherein the clutch actuating system further includes a pressure sensor configured to determine a pressure of a master cylinder of the clutch actuating system, and a displacement sensor configured to determine a distance traveled by a clutch actuator.

15. The clutch actuation system of claim 11, wherein in response to a measured duration exceeds a time threshold, a plausibility check is executed.

16. The clutch actuation system of claim 11, wherein the controller is further configured to determine a rotational speed used when the unintended slip is above a rotational speed threshold.

17. The clutch actuation system of claim 11, wherein the clutch is a wet clutch.

18. A method for determining a service life of a clutch of a vehicle with a clutch actuation system, comprising:
setting a maximum torque at the clutch of the clutch actuation system;
incrementing a service life counter when an unintended slip at the clutch occurs;
determining that wear has occurred on the clutch in response to reaching a specific counter value of the service life counter; and
multiplying a weighted sensitivity factor by a first absolute value in response to an unintended slip occurring.

19. The method of claim 18, wherein the first absolute value increments the counter.

20. The method of claim 19, wherein the counter is reduced by a second absolute value when the unintended slip does not occur.
